(19) United States
(12) Patent Application Publication
(10) Pub. No.: US 2009/0282063 A1
(43) Pub. Date: Nov. 12, 2009

(54) USER INTERFACE MECHANISM FOR SAVING AND SHARING INFORMATION IN A CONTEXT

(76) Inventors: John J. Shockro, North Attleboro, MA (US); Jean-Marie Dautelle, St. Remy-les-Chevreuses (FR); Colin R. Greenlaw, Marlborough, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/436,948

(22) Filed: May 7, 2009

Related U.S. Application Data
(60) Provisional application No. 61/052,355, filed on May 12, 2008.

(51) Int. Cl. G06F 7/00; G06F 12/00; G06F 12/16

(52) U.S. Cl. 707/100; 707/200; 707/204; 707/E17.01; 707/E17.028; 711/E12.001; 711/E12.103

(57) ABSTRACT

A system includes a storage medium having stored instructions that when executed by a machine result in a clip entity associated with metadata and with at least one displayed object, and a clip tray having at least one stack, the at least one stack associated with a plurality of clip entities and to define an aggregation of metadata.

### RELATED APPLICATIONS

This application claims the benefit of U.S. Provisional Application No. 61/052,355 filed May 12, 2008 under 35 U.S.C. §119(e) which application is hereby incorporated herein by reference in its entirety.

### FIELD OF THE INVENTION

The systems, techniques, and concepts described herein relate to the saving and sharing of information in a context, such as a context related to homeland security or weather-related events of national significance. In particular, the system, techniques, and concepts relate to a semantic clipboard software tool that allows users to add information and group the information.

### BACKGROUND

As is known in the art, incident management requires information in many forms and from many different sources (e.g., documents, maps, geographic information, hazmat data, database tables, etc.) to understand an incident and arrive at well-informed decisions, accomplish tasks, and to inform others about what is currently known. Users such as first responders and incident managers often have access to large amounts of incident information, as well as presorted and predefined information (e.g., vehicle identification databases, law enforcement criminal profiles, etc.) but have no way of capturing, collecting, and conceptually grouping the information to help inform decision-making tasks and to mitigate the consequences of an incident. Further, users have no way to aggregate information to store and review when needed and/or to share with others who may benefit from such pre-aggregated information.

### SUMMARY

The systems, techniques, and concepts described herein are directed toward aggregating, saving, and sharing information between a plurality of groups (for example, different government agencies) using a semantic clipboard system. An exemplary application of the system involves an incident of national significance, such as a hurricane, in which federal, state, and local agencies must work together to resolve problems and mitigate the consequences of the incident. Users at the various agencies use the semantic clipboard software tool to select information of interest, for example, items displayed on a geographic map, and add the information to a clipboard tray. The users may select and add multiple pieces of information to one or more stacks in the clipboard tray to group the information.

The information includes metadata, such as a user's name, current date, map coordinates, object type, etc. Once the user adds information to a stack, the information's metadata is aggregated with other metadata on the stack. The adding of information to a clipboard tray may be accomplished via a so-called drag-and-drop operation. For example, a user may select multiple pieces of information related to a three-alarm fire affecting multiple buildings in a city block or neighborhood. The information may include the affected addresses, the current trucks at the scene, the trucks on route to the scene, and law enforcement personnel charged with securing the area.

Using an exemplary application incorporating the inventive systems, techniques, and concepts described herein, a user can aggregate metadata related to an incident, for example, the three-alarm fire described above, and share the aggregated metadata with other agencies. For example, a dispatcher can drag-and-drop information related to fire trucks dispatched to the scene to a “fire truck” stack located in a clipboard tray, which may be displayed on a computer display screen. Each fire truck may be represented by an icon and relates to stored information about the fire truck, such as water cannon capacity, number of fire personnel in transport, fire house station, and current location. The fire truck information is automatically added to the stack as a separate item to be grouped with other items added on the stack as a result of the drag-and-drop operation. The dispatcher can add other fire truck information to the stack, such as an estimated time-of-arrival of a fire truck to the scene.

In this way, the aggregated fire truck information represents a conceptual grouping of fire trucks assigned to the three-alarm fire. The dispatcher may use the aggregated information at a later time to recall information about the dispatched fire trucks and, for example, assess whether more (or less) assistance may be needed based on a status update of the three-alarm fire. Further, responders at the scene of the three-alarm fire may download the aggregated information. For example, a fire marshal can download the fire truck information to a mobile device (e.g., a portable lap top, portable data assistant, etc.) to determine how to assign the fire trucks to different locations of a burning building. For example, the fire marshal may review the aggregated fire truck information to discover that one of the fire trucks has a more powerful water cannon and more experienced fire personnel and, based on this information, assign the fire truck to a portion of the burning building where victims may be trapped on a higher floor. Such information-based planning before the arrival of the fire trucks may save precious time and mitigate the consequences of the fire.

Further, the fire marshal may enter information on a portable device regarding fire victims, such as type of injury, physical attributes, pulse rate, medical condition, etc. and add the information to a version of the semantic packager system executing on the portable device. For example, the fire victim information can be added to a “fire victim” stack to be aggregated and shared with local area hospitals. Local hospitals, for example, may download the aggregated fire victim information from a central server or peer-to-peer web services.

As described above, the semantic clipboard system includes a clipboard tray which is a temporary scratchpad storage mechanism whose characteristics can be configured to suit various user roles and responsibilities. Example user roles include, but are not limited, an incident supervisor, a member of a medical staff, a law enforcement official, etc. A user may add information to the clipboard tray until the user has a need to recall the information, for example, by clicking on an icon representing the information. For example, a user who is a law enforcement person at the scene of an accident may drag a vehicle description report to the clipboard tray on a hand-held device and at a later time click on an icon representing the vehicle description report in order to share the information to another law enforcement person arriving at the accident scene.

The clipboard tray includes stacks for grouping pieces of information. When a user adds multiple pieces of information to the stack, the semantic clipboard tool combines the metadata of the pieces of information to create an aggregation of metadata. In an exemplary application, the aggregation of metadata is mapped to a semantic model related to an incident and a user role. If the clipboard cannot automatically create a semantic mapping, a dialog window may be opened to allow the user to manually define the semantic mapping. For example, the dialog window may include input boxes to allow the user to input related concepts and the relationship between the concepts.

After the user combines the information, the user may package and export the information to a semantic archive file using a semantic packager as described in co-pending provisional U.S. patent application Ser. No. 61/052,349, entitled, “Semantic Packager”, to John J. Shockro et al. Such a semantic archive file can be transferred and shared with other users who can import and view the information.

In one aspect, a system includes a storage medium having stored instructions that when executed by a machine result in a clip entity associated with metadata and with at least one displayed object, and a clip tray having at least one stack, the at least one stack associated with a plurality of clip entities and to define an aggregation of metadata.

In further embodiments, the system includes one or more of the following features: the clip entity is further associated with a text file, an audio file, or a video file; the metadata includes a semantic model including at least one relationship between a plurality of metadata attributes; the storage medium further provides a stack exporter to export the aggregation of metadata and a stack importer to import the aggregation of metadata; and the stack exporter is configured to export the aggregation of metadata to a file.

In another aspect, a computer implemented method includes selecting a clip entity associated with metadata and with a displayed object, adding the clip entity to a clip tray comprising at least one stack, and creating an aggregation of metadata associated with each stack based on the clip entities added on the stack. In a further embodiment, the method includes saving the aggregation of metadata in a file.

### BRIEF DESCRIPTION OF THE DRAWINGS

The foregoing features of the system, techniques, and concepts may be more fully understood from the following description of the drawings in which:

FIG. 1 is a block diagram of a semantic clipboard system according to the inventive systems, techniques, and concepts described herein;

FIG. 2 is a block diagram of a networked environment for use by the semantic clipboard system of FIG. 1;

FIG. 3 is a pictorial representation of an exemplary embodiment of a display having displayed thereon components of a semantic clipboard system for saving and sharing information in a context;

FIG. 4A is a diagram of an embodiment of a semantic model of the type which may be used with the semantic software system of FIG. 3;

FIG. 4B is a diagram of an embodiment of a semantic model instance for the semantic model of FIG. 4A;

FIG. 5A is a block diagram of an embodiment of a clip entity class hierarchy;

FIG. 5B is a block diagram of an embodiment of a clip try class hierarchy;

FIG. 6 is a pictorial representation of a more detailed embodiment of the semantic software system of FIG. 3;

FIG. 7A is a diagram of an embodiment of a semantic model of the type which may be used with the semantic software tool of FIG. 6;

FIG. 7B is a diagram of an embodiment of a semantic model instance for the semantic model of FIG. 7A; and

FIG. 8 is a flow diagram of an embodiment of a method for saving and sharing information in a context.

### DETAILED DESCRIPTION

In general overview, the systems, techniques, and concepts described herein can be described as a semantic clipboard system for aggregating, saving, and sharing information in a context related to a real-world event such as a hurricane, earthquake, release of a bio-agent, or other events. Such events have one thing in common; they require the sharing of information in a timely fashion between local, state, and federal agencies who must work together to solve problems and mitigate the consequences of the event. For example, persons associated with federal agencies can use the system to aggregate, save, and communicate context-related information with local users, for example, emergency responders at a location which the event began (i.e., the scene of the event). In an exemplary application of the system, users deployed at secured facilities may use a standalone version of the semantic clipboard system executing on a workstation to create and share information with local responders over a secure network. The local responders can download and view the information on a mobile device. The local responders can further update and upload information from the scene using, for example, a mobile device version of the semantic clipboard system.

The system is not limited to events of national significance. For example, the event to be mitigated may involve a warehouse fire and may engage local law enforcement and fire officials, and medical dispatch teams. The system is also not limited to emergencies or disastrous events and may be directed toward, for example, process-oriented work flows, such as product manufacturing and distribution operations in which various groups must share information. Using an exemplary application of the system, a manufacturing group may share information related to a breakdown at a manufacturing facility. For example, a robotic system may experience a breakdown, halting an assembly line. The manufacturing group may save and share information related to the breakdown, such as an estimated time-to-resolution, affected products, and product distributers. The information can be shared with product distributers who can inform product customers of the delay (or obtain product from another source).

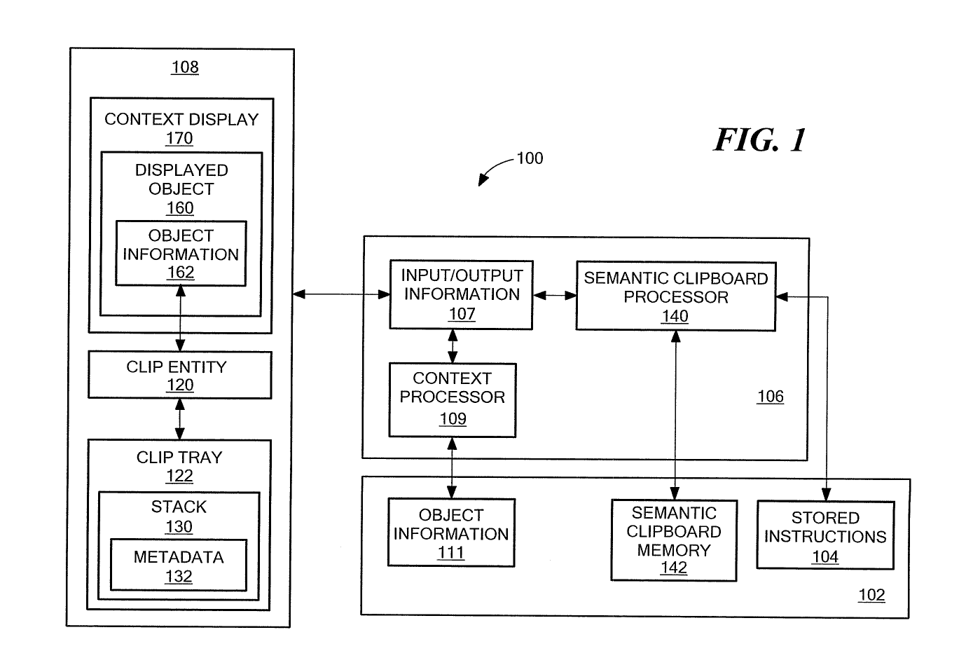

Referring now to FIG. 1, a semantic clipboard system 100 includes a storage medium 102 having stored instructions 104 that when executed by machine, such as processor 106, result in a clip entity 120 associated with metadata 132 and with at least one displayed object 160, as may be displayed in context display 170 on display 108. As will be further explained in detail below, in one embodiment, the clip entity 120 is a displayed user interface object (e.g., an iconographic of a file) that is associated with another displayed object 160 selected by a user in a context display 170. In this embodiment, the context display 170 is a geographic map, and the displayed object 160 is a point of interest on the map. The displayed object 160 includes object information 162, such as a text-based description of the point of interest and the geographic coordinates of the point of interest.

A user can create and add the clip entity 120 to the clipboard tray 122 using a variety of input/output methods. For example, the user may toggle a button on display 108 to activate a clip-entity-creation mode. In such a mode, the clip entity 120 is created when the user selects the displayed object 160 on context display 170. This operation also associates the object information 162 of the displayed object 160 with the clip entity 120. The clip entity 120 is associated with metadata 132 which may include at least a portion of the object information 162, as well as other contextual information, such as information entered by the user.

The user may drag-and-drop the clip entity 120 to the clip tray 122, which adds the clip entity 120 to the clip tray 122 and, in particular, to the stack 130. Multiple clip entities 120 may be added to the stack 130 in order to group clip entities 120. The stack 130 defines an aggregation of metadata 132 which includes the object information and other contextual information, as will be explained in further detail below.

The processor 106 may include other components to support the operation of the semantic clipboard system 100. In one embodiment, a semantic clipboard processor 140 supports the operation of clip entity 120, the clip tray 122, the stack 130, and aggregation of metadata 132. A semantic clipboard memory 142 stores clip entity 120 and/or clip tray 122 created during the operation of the semantic clipboard system 100. The semantic clipboard memory 142 also stores stack 130 and aggregated metadata 132. In one embodiment, a stack 130 is represented by a linked list object. Each item on the list references a stack object, which may include a linked list of clip entities stored on the stack. Furthermore, object information may be stored with each clip entity. The semantic clipboard memory 142 also stores aggregated metadata 132. In one embodiment, the aggregated metadata includes a hierarchy of grouped objects and object attributes. For example, in the fire truck stack example above, the aggregated metadata may be represented by an object-oriented class hierarchy of fire truck objects. The fire truck object may reference other class objects, such as water cannons and personnel on the fire truck.

The processor 106 may also include an input/output processor 107 to support display 108 and direct various user operations to other processor components, such as the semantic clipboard processor 140 and the context processor 109. The context processor 109 supports the context display 170, including various operations associated with the context display 170. For example, the context processor 109 may support zoom in/out capabilities of a geographic map. The context processor 109 may store object information in an object information memory 111. The object information 111 may include object attributes, such as a text-based description and geographic coordinates for a point of interest on a geographic map.

The input/output processor 107 directs user interface operations of the clip entity 120, clip tray 122, and stack 132 to the semantic clipboard processor 140. For example, the input/output processor 107 can pass displayed object information 160 of a selected object to the semantic clipboard processor 140 during the creation of clip entities 120. In response, the semantic clipboard processor 140 creates a clip entity 120. The input/output processor 107 can indicate to semantic clipboard processor 140 that a clip entity 120 has been dropped on a stack 130. In response, the semantic clipboard processor 140 passes metadata associated with the clip entity 120 and aggregates the metadata with existing metadata 132 on the stack 130.

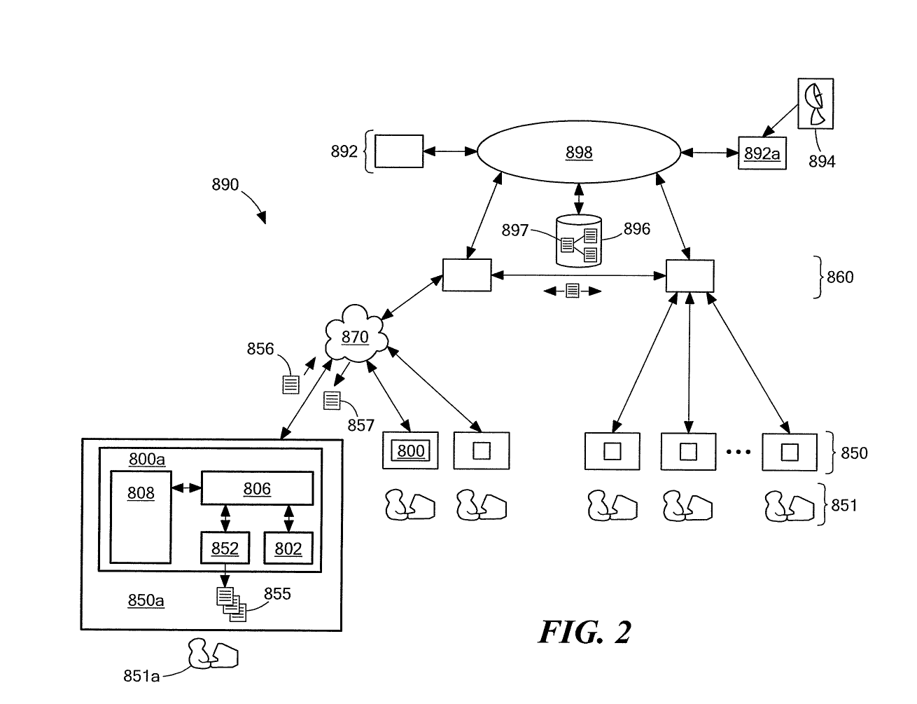

Referring now to FIG. 2, an exemplary networked environment 890 for use with embodiments of the inventive concepts described herein includes clients 850 executing instances of a semantic clipboard system, generally designed by reference numeral 800, and communicating with servers 860 over a network 870. The instances of the semantic clipboard system 800 may be exemplified by a particular instance 800a executing on a client 851 a and including a display 808, a processor 806, and a storage medium 802, as may be similar to display, processor, and storage medium described in conjunction with FIG. 1. In a further embodiment, semantic clipboard system 800a includes an import/export processor 852 to import and export aggregated metadata 855, as may be similar to aggregated metadata described in conjunction with FIG. 1.

Users 851 of the networked environment 890 may share aggregated metadata 855 in a variety of ways. In one embodiment, user 851a exports aggregated metadata 855 and uploads the data 856 over the network 870 to one or more of the servers 860. The one or more servers 860 may collect and save the uploaded aggregated metadata and share the data with other users 851 across the network 870. In another embodiment, other users 851 of the networked environment 890 upload aggregated metadata to one of the server 860 and user 851 a downloads the metadata 857.

In still another embodiment, the user 851a exports an aggregated metadata file, which includes the metadata and may include other information, such as file versioning. The file may be shared with one or more of the other users 851. In the same or different embodiment, the user 851 a imports an aggregated metadata file, for example, one shared by one or more of the other users 851.

The network 870 may include, but is not limited to, the Internet and/or an intranet. A database management system 896 may be connected to the network 870 and used to store aggregated metadata in a relational database 897 that users 851 may query based on certain desirable criteria. In one example, user 851a queries the relational database 897 to find aggregated metadata for fire trucks recently used for fires. The user 851a may use such data to determine whether maintenance needs to be performed on the fire trucks.

The networked environment may include a private network 898 including one or more information servers 892 for obtaining information from external sources, such as radar tracking systems and geo-coding engines. For example, information server 892a may obtain radar tracking data for aircraft from a radar tracking system 894. The radar tracking data may be communicated over the network 870 to one or more of the clients 850, where it used in a context display for displayed objects and/or object information, such as those described in conjunction with FIG. 1. As explained above with reference to FIG. 1, the information may be used to create clip entities to copy to stacks and create aggregated metadata, for example, to describe aircraft.

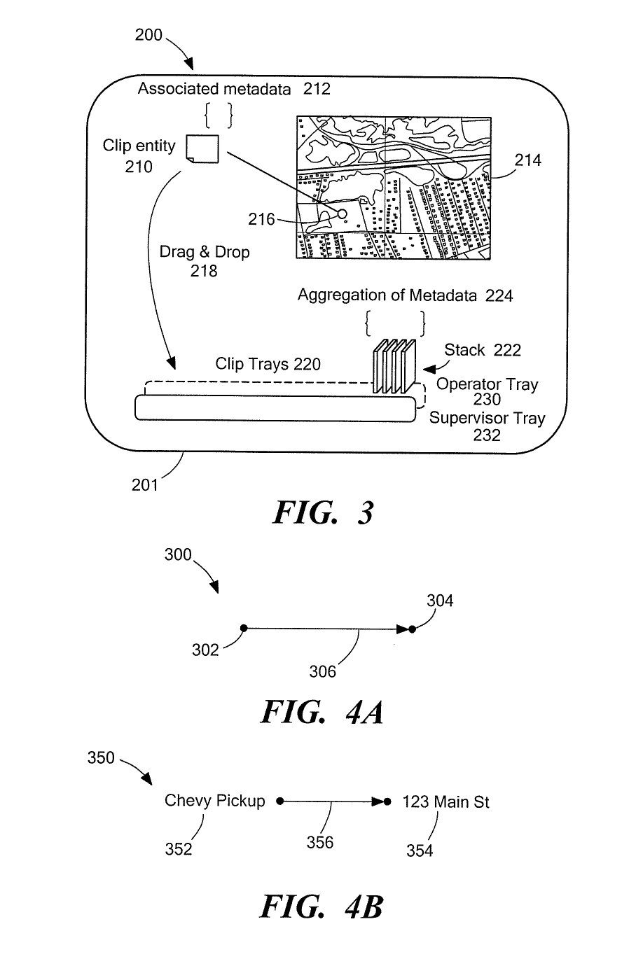

Referring now to FIG. 3, an exemplary embodiment of a semantic clipboard software system 200 for saving and sharing information in a context includes a clip entity 210 and a clip tray 220. The clip entity 210 is a displayed object that corresponds to user-selected contextual information 216 displayed on a user interface display 201. In one example, the user-selected contextual information 216 includes a geographic area on a map 214 that corresponds to a tornado-damaged region. In another example, the user-selected contextual information is a point of interest on the map 214 that corresponds to ground zero for the release of a bio-agent. The contextual information 216 includes metadata 212, such as the coordinates of the selected bounding box or textual information related to the selected point of interest. The metadata 212 is associated with the clip entity 210. In an example embodiment, the metadata 212 includes at least a portion of the user-selected contextual information as may be similar to object information 162 of displayed object 160 described in conjunction with FIG. 1. The metadata 212 may also include user-entered information, such as a real-time status of the selected object known by the user. In the same or different embodiment the metadata 212 is copied from the object information and/or user-entered information into the clip entity object. For example, the metadata 212 may be copied into a semantic clipboard memory as may be similar to semantic clipboard memory 142 described in conjunction with FIG. 1

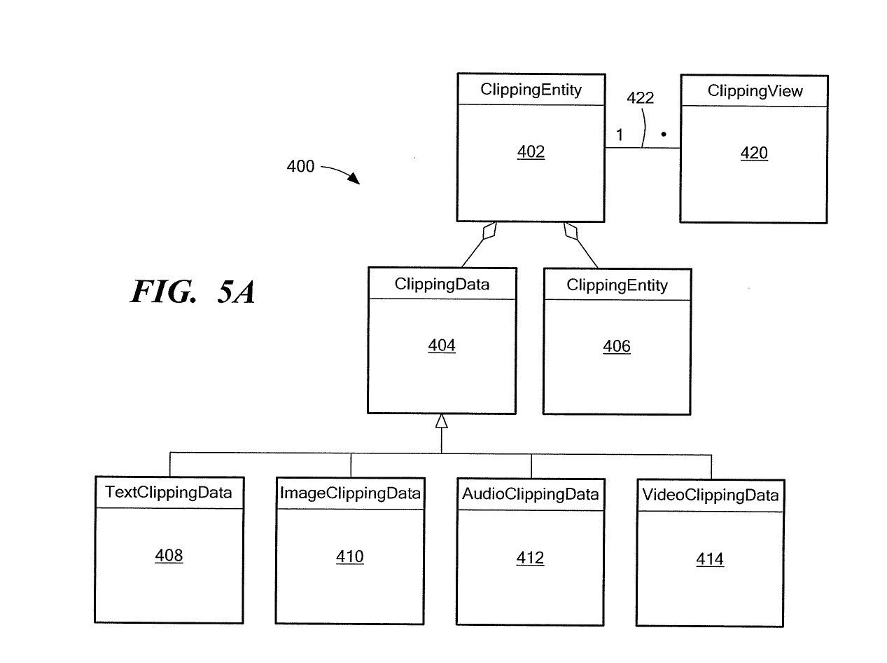

The clip tray 220 is a displayed user interface object having one or more stacks 222 for grouping clip entities 210. In one embodiment, users define stacks 222 by adding (e.g., by dragging and dropping) the clip entities 210 representing selected contextual information 216 to one of the displayed stacks. The semantic clipboard system aggregates the metadata 224 associated with each clip entity on the stack 222. For example, as described above in conjunction with FIG. 1, the aggregated metadata 224 may be represented in an object-oriented class hierarchy and stored in a semantic clipboard memory. In one embodiment, the metadata 224 is parsed into entities and entity relationships based upon a semantic model to create semantic model instances as described below in conjunction with FIGS. 4A and 4B. Optionally, the associated metadata 212 can be grouped and categorized across stacks 222 according to predefined criteria or user instructions. For example, the metadata may be categorized by security level, user role, and user expertise.

The clip tray 220 may be associated with a user role, such as a supervisor role, or an operator role. For example, an operator user may be responsible for selecting, and adding clip entities 210 to the stacks 222 in an operator tray 230 (as indicated by the arrow designated by reference numeral 218), while a supervisor user may be responsible for confirming stack contents, creating the aggregation of metadata in the supervisor tray 232, and sharing the aggregation of metadata with other groups.

Referring to FIG. 4A, in a further embodiment, the associated metadata is a semantic model 300 including relationships between information in a context. The semantic model 300 includes a first node 302 designating an object, a second node 304 designating another object, and a line 306 between the first and second nodes 302, 304 designating a relationship between the node objects. In the exemplary embodiment of FIG. 4A, line 306 has a direction which points from the first object 302 to the second object 304, meaning that the second object 304 provides descriptive information for the first object 302. Referring now to FIG. 4B, a semantic model instance 350 may include vehicles of a predefined type, for example a Chevy Pickup 352, and locations 354, which may include street addresses (such as 123 Main Street) or geographic coordinates (such as latitude/longitude coordinates). Here, line 356 indicates that the Chevy Pickup is located at 123 Main St.

In one embodiment, a natural language processor is used to parse text-based metadata and conform the metadata to the semantic model 300 and to define the semantic model instance 350. For example, a search of the term “Chevy Pickup” is performed against a catalog of real-world objects represented in the semantic model. The catalog includes a text string to describe the type of object, for example, “vehicle”, and the name of the object. Furthermore, the catalog defines attributes of objects and relationships of objects to other objects. For example, the catalog indicates that a vehicle has a location, the location including two geographic coordinates. Here, a search of the catalog indicates that “Chevy Pickup” is a type of vehicle. A semantic model instance of a vehicle is defined for the Chevy Pickup. The natural language processor searches the metadata for geographic coordinates to define the vehicle's location. The natural language processor continues to process the metadata until all the metadata is accounted for and/or cannot be conformed to any semantic model object.

Referring again to FIG. 4A and to FIG. 4B, the semantic model 300 is typically created before the occurrence of an incident and the semantic model instances 350 are created during the incident. Alternatively, the semantic model 300 may be created dynamically during an incident, for example, to create relationships between various objects and events as they occur. For example, a semantic model 300 may be created during an incident as the need to track and coordinate aircraft from outside groups becomes apparent. The semantic model instances 350 may be created as various aircraft take-off and land.

Object definitions for the semantic model instances 350 are also typically created before the incident and incorporated into the system during the incident. For example, a database of vehicles (such as vehicle manufacturers, models, years, etc.) may be used to create semantic model instances related to vehicles. During the incident, users can select vehicle make and model from a list populated by the object definitions to create each semantic model instance 350 and the system may automatically merge vehicle make and model information with vehicle location information obtained via, for example, a GPS or eyewitness accounts.

Referring again to FIG. 3, the clip entity 210 may be further associated with a data file, such as a text, audio, image and/or video data file. Alternatively, the data file may include geographic coordinates or annotated map objects referenced in a Geographic Information System or a map file.

In still another embodiment, the clip entity 210 is associated with a data reference, for example, a data memory reference (such as a memory address) or data source reference (such as geo-data source).

In a further embodiment, the system includes a stack exporter to export an aggregation of metadata, and a stack importer to import an aggregation of metadata. In still a further embodiment, the stack exporter exports the aggregation of metadata to a data file, and the stack importer imports the aggregation of metadata from the data file. The metadata may be saved in a specific format, such as one used for weather-related information. The format may be encrypted to enhance data security and/or compressed to increase data transfer rate and/or reduce network load.

The system is implemented using stored instructions saved in a storage medium, such as a data disk or computer memory. In one embodiment, the stored instructions are software instructions written in a programming language, such as C++ or Java, and developed using an Integrated Development Environment (IDE). The software instructions are defined and edited in one or more software modules or files. The software modules or files are debugged and compiled into one or more executable programs which are loaded into a computer memory for execution. In one embodiment, a standalone executable program is loaded and executed on a computer. Alternatively, one or more client and server executable programs are loaded and executed on a client and server system. The client and server system may be coupled over a network, such as an intranet or the Internet.

The executable program may be saved on a disk, such as a compact data disk and transported from one computer platform to another. Alternatively, the executable program may be downloaded or transferred over a network as an installable plug-in or service.

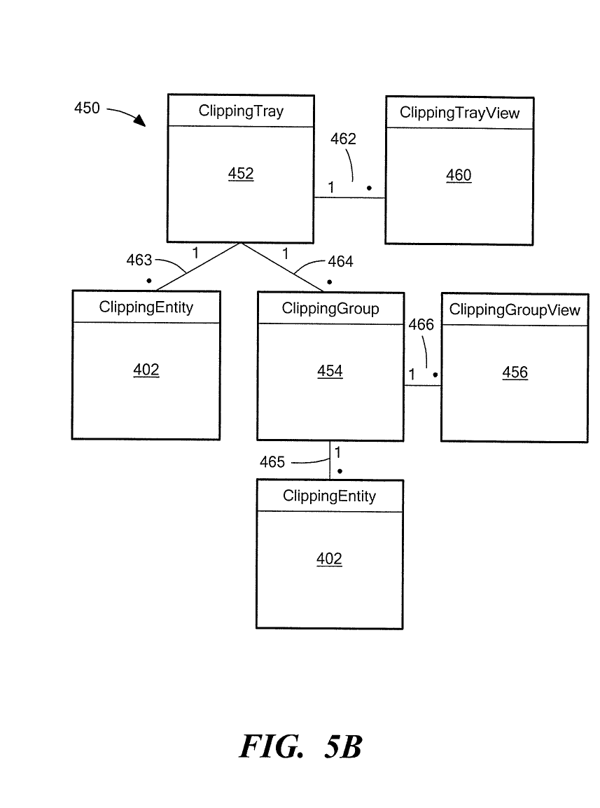

Referring now to FIGS. 5A and 5B, one or more object class hierarchies may be used to implement the semantic clipboard system. In FIG. 5A, a clipping class object hierarchy 400 is shown in which a ClippingEntity class object 402 represents an instance of a clip entity and encapsulates a ClippingData class object 404 and a ClippingContext class object 406. The ClippingData class object 404 represents an instance of the data being clipped and includes subclasses TextClippingData 408, ImageClippingData 410, AudioClippingData 412, and VideoClippingData 414. Each of these subclasses 408, 410, 412, 414 represents different data types, for example, text data, image data, audio data, and video data. The ClippingContext class object 406 represents an instance the data context, for example, a map of an earthquake-devastated urban area. The ClippingView class object 420 represents a visualization of an instance of a ClippingEntity class object 402. As shown by the line designated by reference numeral 422, a ClippingView instance may visualize multiple ClippingEntity instances.

In FIG. 5B, a clipping tray class object hierarchy 450 is shown in which a ClippingTray class object 452 represents an instance of a clip tray and implements a container for ClippingEntity class objects 402 and ClippingGroup class objects 454. The ClippingTray class object 452 may contain one or more ClippingEntity class objects 402 and ClippingGroup class objects 454 as shown by the lines designated by respective reference numerals 463 and 464.

Each ClippingGroup class object 454 may contain one or more ClippingEntity class objects 402 as shown by the line designated by reference numeral 465. The ClippingGroupView class object 456 represents a visualization of an instance of one or more ClippingGroup class objects 454, as shown by the line designated by reference numeral 466.

The ClippingTrayView class object 460 represents a visualization of an instance of one or more ClippingTray class objects 452, as shown by the line designated by reference numeral 462.

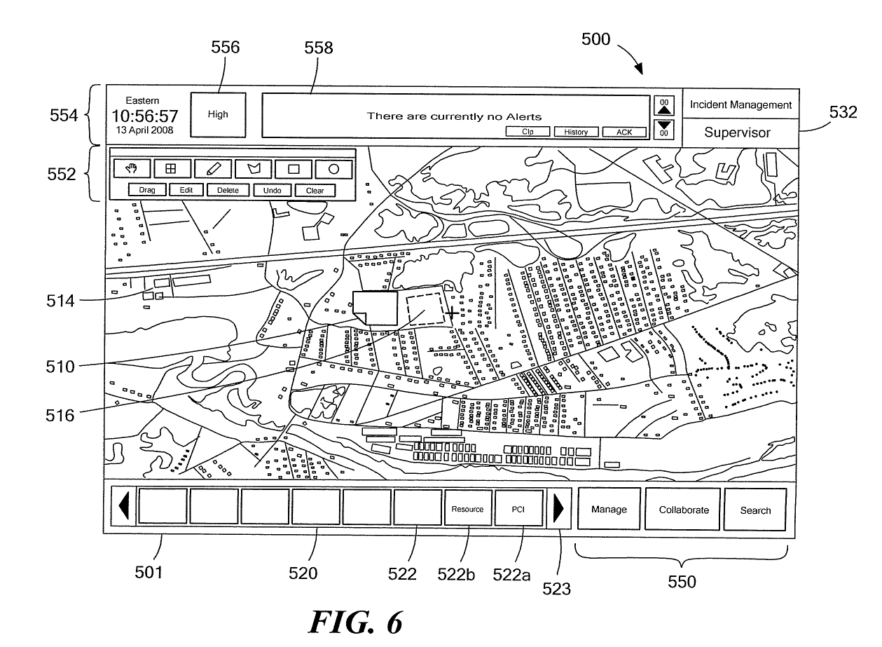

Referring now to FIG. 6, in one embodiment of the system 500, a user interface 501 includes multiple components to assist users in the management of information in a context. The user interface includes a displayed clip tray 520 including multiple stacks 522 as may be similar to stacks 222 described in conjunction with FIG. 3. The stacks 522 can be brought into and out of view using toolbar buttons 523. Map 514 shows a displayed clip entity 510 associated with selected contextual information 516 which a user may add (e.g., drag and drop) to the clip tray 520 at first stack 522a or second stack 522b. Stacks 522a and 522b allow the user to group clip entities representing related contextual information. For example, stack 522a may include points of interest and stack 522b may include dispatch resources on map 514.

A set of buttons 550 controls various functions of the system, including system management, collaborative options, and searches. A toolbar 552 includes icons and buttons for adding, modifying, and deleting various displayed items on the map 514. A date/time area 554 indicates the current date and time. A status area 556 indicates a current risk status, such as high, medium, or low. The risk status may be related to homeland security risks. An information area 558 displays various system messages, such as information related to any present alerts. A user role identification area 532 indicates the role of the current user.

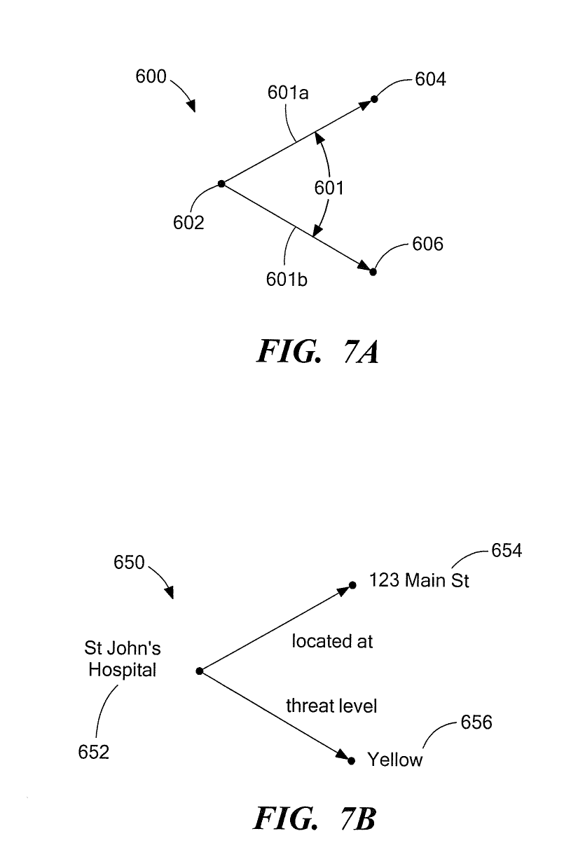

Referring now to FIG. 7A, in one embodiment the metadata includes a semantic model 600 as may be similar to semantic model 300 described in conjunction with FIG. 4A. The semantic model 600 represents metadata relationships 601. A first node 602 of the semantic model 600 may represent a point of interest and a second node 604 of the semantic model 600 may represent a location of the point of interest, wherein a relationship 601a between the first and second nodes 602, 604 includes “located at.” A third node 606 of the semantic model 600 may represent a threat level, wherein a relationship 601b between the first and third nodes 602, 606 includes “threat level.”

Referring now to FIG. 7B, each clip entity adds a semantic model instance 650 to the stack, as may be similar to semantic model instance 350 described in conjunction with FIG. 4B. For example, semantic model instance 650 may include point of interest “St John's Hospital” 652 located at “123 Main St.” 654 and having a threat level of “yellow” 656.

In a further embodiment, the user exports the aggregated metadata. For example, the exported metadata may be exported as a data file or downloaded over a network. In another embodiment, the user imports the aggregated metadata data, which may automatically populate a clip tray (as may be similar to clip tray 520 of FIG. 6) with the imported data. For example, an item of a stack may be created for each imported semantic model instance. In one embodiment, a user interface is enabled to hi-light displayed objects which correspond to semantic model instances. For example, a user may import a data file of aggregated metadata and the user interface may automatically hi-light each of the semantic model instances on a map, as may be similar to map 514 described in conjunction with FIG. 6.

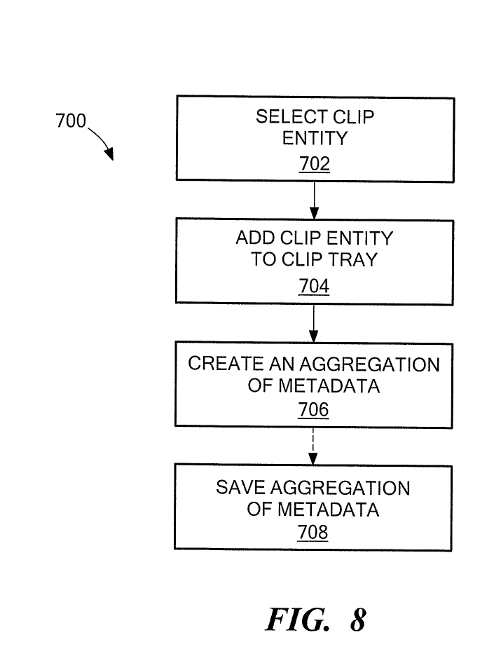

Referring now to FIG. 8, a method 700 includes selecting a clip entity 702 associated with metadata and with a displayed object, adding the clip entity 704 to a clip tray comprising at least one stack, and creating an aggregation of metadata 706 associated with each stack based on the clip entities added on the stack. The method may further include saving the aggregation of metadata 708 in a file and sharing the aggregation of metadata between users of a system for managing and mitigating the consequences of an incident.

Having described preferred embodiments of the system, techniques, and concepts, scope of protection afforded by this patent will now become apparent to those of ordinary skill in the art that other embodiments incorporating these systems, techniques, and concepts may be used. Accordingly, it is submitted that the scope of protection afforded by this patent should not be limited to the described embodiments but rather should be limited only by the spirit and scope of the appended claims.

1. A system comprising:
a storage medium having stored instructions that when executed by a machine result in the following:
a clip entity associated with metadata and with at least one displayed object; and
a clip tray having at least one stack, the at least one stack associated with a plurality of clip entities and to define an aggregation of metadata.

2. The system of claim 1 wherein the clip entity is further associated with a text file, an audio file, or a video file.

3. The system of claim 1 wherein the metadata comprises a semantic model 12 comprising at least one relationship between a plurality of metadata attributes.

4. The system of claim 1 wherein the storage medium further provides:
a stack exporter to export the aggregation of metadata; and
a stack importer to import the aggregation of metadata.

5. The system of claim 4 wherein the stack exporter is configured to export the aggregation of metadata to a file.

6. A computer implemented method comprising:
selecting a clip entity associated with metadata and with a displayed object;
adding the clip entity to a clip tray comprising at least one stack;
creating an aggregation of metadata associated with each stack based on the clip entities added on the stack.

7. The method of claim 6 further comprising:
saving the aggregation of metadata in a file.
